(19) United States
(12) Patent Application Publication
(10) Pub. No.: US 2006/0129383 A1
(43) Pub. Date: Jun. 15, 2006

(54) Text processing method and system

(75) Inventors: Jon Oberlander, Edinburgh EH9 (GB); Alastair Gill, Edinburgh (GB); Stephen Conway, Edinburgh EH8 (GB)

Correspondence Address: LOWRIE, LANDO & ANASTASI, RIVERFRONT OFFICE, ONE MAIN STREET, ELEVENTH FLOOR, CAMBRIDGE, MA, 02142, US

(73) Assignee: The University Court of the Universityof Edinburgh, South Bridge (GB)

(21) Appl. No.: 10/512,154

(22) PCT Filed: Apr. 25, 2003
(86) PCT No.: PCT/GB03/01803

§ 371 Date: Jan. 20, 2006

(30) Foreign Application Priority Data
Apr. 26, 2002 (GB) 0209563.6

(51) Int. Cl. G06F 17/21

(52) U.S. Cl. 704/10

(57) ABSTRACT

A method of processing text is provided, in which each word or sequence of words is checked against a lexicon of words and sequences of words each having, associated therewith a score on at least one personality scale, which can be a multi-dimensional scale for representing various personality traits. These scores are then compared against a target personality, and, if the score has a predetermined degree of mismatch with the target personality, a word or sequence of words with a similar semantic content but a better matching score on the personality scale is retrieved.

This invention relates to text processing, and more particularly to an automated system and method for analysing and editing the style of a text for the purpose of matching the style to a target audience.

There are a number of well known style checkers, such as Epistle, Grammatik and the style checker built into Microsoft Word. All of these identify patterns in text documents and, according to a set of predefined rules, identify particular patterns as bad and in need of correction, or identify these as bad and suggest a correction. For example, long sentences are highlighted, along with potential break points for making them shorter. Or passives are highlighted and the need to replace them with actives is noted.

However, existing style checkers are devoted to promoting good writing, where “good” means approved of in particular style manuals. These systems are fixed, not allowing for alterations of what is “good” style according to circumstances.

Although writers are not always aware of it, their choice of language is partly related to their own personality, such as their level of extraversion or neuroticism. The language a writer uses gives rise in their readers to impressions about the writer's personality.

For this reason, writers may wish to control the style of language they use in a particular text in order to avoid negative impressions, or to reach particular target markets who are known to prefer some personalities over others.

The present invention aims to address this requirement. The invention differs from conventional style checkers in that it does not identify a single set of “bad” expressions and try to replace them with “good” expressions, but rather allows the user to define the personality they wish their text to project (the target personality).

Accordingly, the present invention in one aspect provides a method of processing text, comprising:

receiving a passage of text to be processed;

identifying words and/or sequences of words within the text passage;

checking each word or sequence of words against a lexicon of words and sequences of words each having associated therewith a score on at least one personality scale;

comparing said scores with a desired target personality on said personality scale; and

if the score has a predetermined degree of mismatch with the target personality, retrieving a word or sequence of words with a similar semantic content but a better matching score on the personality scale.

The personality scale is preferably a multi-parameter scale and may be, for example, Extraversion-Neuroticism-Psychoticism.

Preferably, the lexicon may be derived from automated analysis of material from a statistical sample of subjects, the material including for each subject both personality test data and textual matter relating to one or more given topics.

Optionally, the lexicon may be derived from a set corpus.

Preferably, the words in the set corpus are represented by vectors in a semantic space such that the vector distance between two words provides a measure of their difference in meaning, and the position of a target word on a personality scale in the semantic space is defined as its relative distance from two or more groups of words that are associated with the extrema of the personality scale.

Optionally, the lexicon may be derived from a composite source comprising;

(a) words derived from automated analysis of material from a statistical sample of subjects, the material including for each subject both personality test data and textual matter relating to one or more given subjects; and

(b) a set corpus, in which the words may be represented by vectors in a semantic space such that the vector distance between two words provides a measure of their difference in meaning, and the position of a target word on a personality scale in the semantic space is defined as its relative distance from two or more groups of words that are associated with the extrema of the personality scale.

Preferably, each word or sequence of words is checked against source (a), which source is then used to initiate the step of retrieving a word or sequence of words with a similar semantic content but a better matching score on the personality scale, and, if no such word or sequence of words is retrieved using source (a), a list of synonyms is collated using a thesaurus, which are checked against source (b) to carry out that step.

Optionally, each word or sequence of words is checked against source (b), which source is then used to initiate the step of retrieving a word or sequence of words with a similar semantic content but a better matching score on the personality scale.

From another aspect, the invention provides a computer programmed to carry out the foregoing text processing method.

The invention further provides a data carrier carrying program data for effecting the foregoing text processing method.

Also, the invention provides a computer system containing data defining a lexicon, which lexicon comprises words and sequences of words each having associated therewith a score on one or more scales identifying the likelihood of the respective word or sequence of words being used by a person having a personality trait associated with that scale; the invention further resides in a data carrier carrying the same data.

The invention shall now be described, by way of example only, with reference to the accompanying drawings, in which:

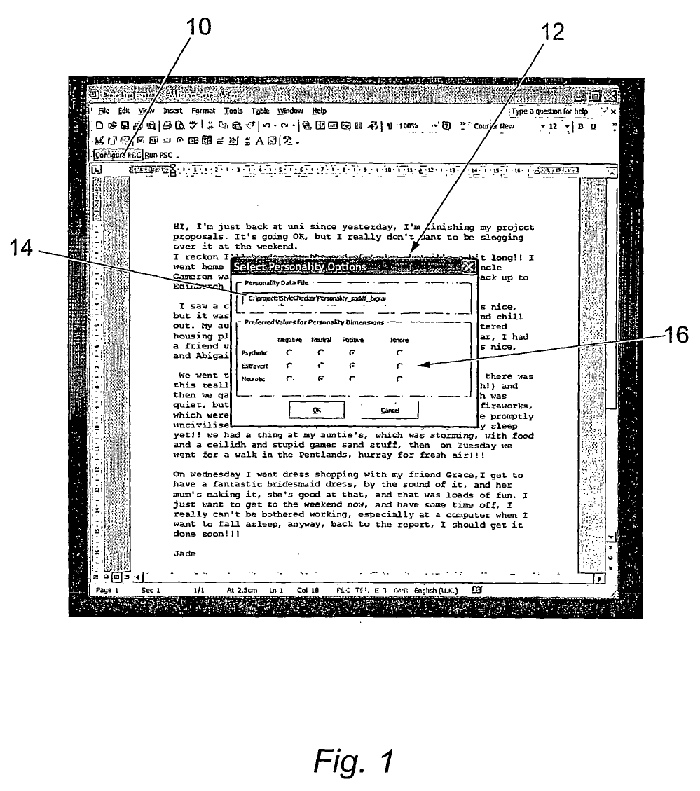

FIGS. 1-4 show screen shots from a computer on which an embodiment of the invention is implemented.

First, the author must define the target personality. It is preferred to define the target personality in terms of multiple parameters. Two suitable formats which are generally available and understood are Eysenck's EPQ-R test [1] and Costa and McCrae's NEO PI-R model [2]. Eysenck reflects a model which incorporates Extraversion (E), Neuroticism (N) and Psychoticism (P). Costa and McCrae also use Extraversion and Neuroticism but couple these with Conscientiousness, Agreeableness and Openness. Either of these models may readily be used in the present invention, as may be any other model which gives a reasonably accurate, practical measure of personality differences.

The system makes use of a lexicon of words and sequences of words, with each of the words or sequences categorised by values of personality parameters.

For example, Eysenck's EPQ-R test [1], incorporating Extraversion (E), Neuroticism (N) and Psychoticism (P) can be used to define personality parameters of E, N and P, where extraversion is mainly characterised by being sociable, needing people to talk to, craving excitement, taking chances, being easygoing and optimistic, neuroticism is mainly characterised by susceptibility to anxiety, and psychoticism is generally related to aggression and individuality.

It will be understood the above parameterisation is only one possible option among many that could be used.

Since the lexicon categorisation is multi-parameter, these can be regarded as located in regions of a “personality space,” the dimensions of which are defined by the parameter scales.

After the target personality is defined, the system then classifies the text as a whole, to quantify how close it is to projecting the target personality. This is done by using a suitable algorithm to look up words and sequences in the lexicon, retrieve the personality parameters, and (optionally) to apply predefined weightings according to the significance of words or sequences within the text.

Next, the system identifies linguistic expressions within the text. These can particularly be words and sequences of words which have parameter values in personality space that are divergent from the parameter values of the target personality. These words or sequences of words are termed “culprits” as they contribute to the personality projected by the overall text being different from the target personality. The criteria for identifying a word or sequence of words as a culprit can, for example, be based on finding a lower score on one or more (as selected) of the parameter scales in personality space.

For each culprit, the system proposes a list of candidate expressions which (a) reduce divergence on a given parameter while leaving the other parameters unchanged, or (b) reduce divergence on the given parameter and also reduce divergence on the other parameters.

To score words and sequences, the system requires a lexicon of words and sequences of words which have been annotated with information about their relation to personality expression. For this purpose, there need be no special structure to the lexicon, beyond the fact that each word or word sequence can be considered a record in a database, and within a given record, there are a number of fields, one for each personality dimension in use. The fields contain values on the dimension. Values on a dimension can be continuous or categorical; that is, values could be rational numbers between −1 and +1; or they could be one of three or more categories: for instance, −, 0 and +. The lexicon and the personality dimension values it contains can be derived by hand, or semi-automatically, by applying statistical analysis techniques to existing lexical resources in the public domain.

To suggest candidates to replace culprits, the system requires some further structure in the lexicon. In particular, records for words and word-sequences must be grouped in terms of their general semantic (and optionally, syntactic) similarity. The groupings can also be derived by hand, or semi-automatically, by applying statistical analysis techniques to existing lexical resources in the public domain.

Like spell-checkers, the system can operate in an interactive or cyclic fashion; that is, after each change the text as a whole, or sections of it, can be re-scored to check the effect of eliminating an existing culprit, or introducing a new one.

The lexicon can be derived empirically from controlled experiments. In one experiment, 105 student volunteers were asked to complete an on-line demographic questionnaire and a version of the Eysenck Personality Questionnaire (Revised short form; Eysenck, Eysenck and Barrett, 1985), following which they composed two e-mails on stated themes. Each respondent's texts were individually processed using the LIWC text analysis program [3]. Items were selected for principal components analysis using the same criteria as Pennebaker and King [4], and a statistical analysis was performed to identify which LIWC variables best identify an author's personality.

A similar exercise on the same data was carried out using the MRC Psycholinguistic Database [5] having first tagged the texts for parts of speech using the MXPOST tagger [6].

Obviously, the accuracy and usefulness of the lexicon can be extended by performing similar empirical investigations on larger numbers of subjects and textual subject-matter.

By way of example, consider the sample text below:

Hello there! Today I had an interview for a new job at the Health Centre. I think it went quite well, I should find out quite soon if I've been successful or not.

Yesterday I went to the gym in the morning and visited Mum at lunchtime. In the afternoon I went to Ikea, but didn't buy anything.

In the evening I went for a walk up Blackford Hill with Jane.

Stay in touch,

M.

In this example, the original personality projected by the author is Neutral Psychoticism, Low Extraversion, and High Neuroticism. For convenience, we annotate this as (0P, −E, +N). The PLC can be used to detect this, and to modify the text in order to project a selected target personality, via options presented to the user.

Suppose it was desired that the text projected a greater level of Extraversion. Then the target personality may be described as:
Target Text 32 (0P, +E, +N),

so that Psychoticism and Neuroticism remain constant.

The first culprit identified will be “Hello”, where we have:

[Hello <−P, 0E, +N> => Hi <0P, +E, −N>; Hey <+P, +E, −N>; Hiya <+P, +E, +N>]

In the above notation, “Hello” is identified as a culprit, since its score for E is neutral (0), and the user would be presented with the alternative candidates “Hi”, “Hey”, or “Hiya”, all of which are more extraverted (having scores of +E). As can be seen from examining the scores for each word contained in the angle brackets, not all responses are equivalent in terms of the overall personality associated with them across multiple dimensions. Therefore which is selected would depend on the overall target personality, and how sensitive this is to manipulation of its personality variables.

In the following culprit, a word variable is presented which is to be filled in by the user themselves:

[there <0P, −E, +N> => NAME <−P, 0E, +N>; dude <+P, +E, −N>]

Therefore, if the user chose to replace “there” with “NAME”, they would have to fill this in themselves. For current purposes, when this has been supplied in the following examples, the words are contained within double quotation marks (“ ”)

The following examples continue with this notation to demonstrate the process: square brackets to encapsulate the culprit word and its candidate replacements; and angle brackets to identify the personality profile associated with each culprit word (or multiple words) selected. It is important to note that in the PLC's actual user interface, the user would not see the notation used here, and instead would have alternative words to the culprits presented to them, for example through a dialogue box. Returning to the “Hello” case, a user would see “Hello” highlighted in their text window, and a pop-up dialogue box suggesting the replacements “Hi”, “Hey” and “Hiya”, with optional visual indicators showing how they also affect the P and N dimensions.

We now illustrate the systematic operation of the checker by considering in turn how the existing sample text would be processed, given two different target personalities. The first target requires greater Extraversion (0P, +E, −N). The second requires lower Neuroticism (0P, −E, −N). Such differing targets mean that differing culprits will be identified; and even if the same word or sequence of words is identified as a culprit, differing candidates may be suggested, depending on the target personality.

[Hello <−P, 0E, +N> => Hi <0P, +E, −N>; Hey <+P, +E, −N>; Hiya <+P, +E, +N>] [there <0P, −E, +N> => NAME <−P, 0E, +N>; dude <+P, +E, −N>] [! <0P, 0E, 0N> => !!! <+P, +E, +N>]

Today I had an interview for a new job at the Health Centre.

[I think <−P, −E, +N> => (OMIT) <P0, E0, N0>] it went quite well, [I should <0P, −E, 0N> => (OMIT “I”) should <0P, +E, 0N>; I will <−P, +E, −N>; I may <−P, 0E, +N>] find out quite [soon <0P, 0E, 0N> => quickly <−P, +E, 0N>] if I've [been successful <−P, −E, −N> => got it <+P, +E, −N>] or not.

[Yesterday <0P, 0E, +N> => on DAY <0P +E, 0N>] I went to the gym in the morning and [visited <0P, 0E, 0N> => saw <+P, +E, 0N>] [Mum <0P, −E, +N> => relatives <−P, 0E, 0N>; friends <−P, +E, −N>] at lunchtime.

In the afternoon I went to Ikea [, but <+P, −E, +N> =>, although <0P, +E, +N>] didn't buy anything.

In the evening I went for a walk up Blackford Hill [with Jane <0P, −E, +N> => “Consider using the construction ‘NAME and I’ in the main sentence clause rather than including this information as an additional preposition” <0P, +E, 0N>].

[Stay in touch <0P, −E, +N> => Take care <−P, +E, −N>]

M.

For concreteness, here is the finished text (0P, +E, +N) resulting from taking the first candidate presented in each case:

Hi “Fred” !!!

Today I had an interview for a new job at the Health Centre.

it went quite well, should find out quite quickly if I've got it or not.

On “Saturday” I went to the gym in the morning and saw relatives at lunchtime.

In the afternoon I went to Ikea, although didn't buy anything.

In the evening “Jane and” I went for a walk up Blackford Hill.

Take care,

M.

Now consider the same input text, given the target text=(0P, −E, −N)

[Hello <−P, 0E, +N> => Hi <0P, +E, −N>; Hey <+P, +E, −N>] [there <0P, −E, +N> => dude <+P, +E, −N>] [! <0P, 0E, 0N> =>. <−P, −E, −N>]

Today I had an interview for a new job at Health Centre.

[I think <−P, −E, +N> => (OMIT) <P0, E0, N0>] it went [quite well <−P, 0E, +N> => very well <+P, 0E, 0N>; really well <+P, 0E, −N>; really nicely <0P, 0E, −N>] [I should <0P, −E, 0N> => I will <−P, +E, −N>] find out quite soon if I've been successful or not.

Yesterday [I went <0P, 0E, +N> => (OMIT “I”) went <0P, 0E, 0N>] to the gym in the morning and visited [Mum <0P, −E, +N> => relatives <−P, 0E, 0N>; friends <−P, +E, −N>] at lunchtime.

In the afternoon [I went <0P, 0E, +N> => (OMIT “I”) went <0P, 0E, 0N>] to Ikea [, but <+P, −E, +N> =>, however <+P, 0E, −N>] didn't buy anything.

In the evening [I went <0P, 0E, +N> => (OMIT “I”) went <0P, 0E, 0N>] for a walk up Blackford Hill [with Jane <0P, −E, +N> => “Consider using the construction ‘NAME and I’ in the main sentence clause rather than including this information as an additional preposition” <0P, +E, 0N>].

[Stay in touch <0P, −E, +N> => take care <−P, +E, −N>], M [. <−P, 0E, +N> => (OMIT “.”)]

Finally, for concreteness, here is the finished text (0P, −E, −N) resulting from taking the first candidate presented in each case:

Hi dude.

Today I had an interview for a new job at Health Centre.

It went very well I will find out quite soon if I've been successful or not.

Yesterday went to the gym in the morning and visited relatives at lunchtime.

In the afternoon went to Ikea, however didn't buy anything.

In the evening went “with Jane” for a walk up Blackford Hill.

Take care,

M

Using the empirically derived lexicon as described above, the relevant words or phrases that are identified as culprits and suggested as alternatives must be part of the empirically defined corpus. Therefore, additional resources can be used to supplement the empirical lexicon.

One such source draws on the theory of vector representations of the semantic distance between words, as investigated by Scott McDonald [7]. Here, common words are selected from the British National Corpus (BNC), and the identity and location of each word's three nearest neighbours on each side are encoded. A relationship is assumed to exist between the contexts and the meaning associated with the word. These encodings are then aggregated to construct a multi-dimensional semantic space where each word is represented by a vector. The distance between two words in semantic space can be calculated, and serves as a measure of the difference between their meanings.

A number of words which are close together in semantic space can form a group, and the distance from a target word to a specific group in semantic space can also be calculated.

We can therefore consider there to be groups in the semantic space of words which are associated with particular personality traits, hereinafter referred to as “personal words”. These personal words are selected in one of two ways. They can be selected from standard adjective measures used to test for personality, for example, from the NEO-PI or IPIP five-factor models. Alternatively, they can be selected following analysis of the statistical sample of subjects, once the words are known to be associated with the particular points on the personality scale.

By using clusters of personal words that are known to lie at opposite ends of a scale, we are able to calculate the semantic distance of a target word from each end of the scale, for example, the relative distances between an “extravert” cluster and an “introvert” cluster.

The relative positions in semantic space of opposite extrema of personal word clusters defines, as a subset of the semantic space, a “vector personality space.”

A word's position in vector personality space can then be used as an additional resource to the empirically defined lexicon, for example:

1. Suggestion of alternatives: if a culprit is identified but no alternatives are suggested by the aforementioned empirical data, then a thesaurus (such as Wordnet) can generate alternative synonyms. These can then be rated for personality projection by comparing their positions in vector personality space. Only those alternatives that give values consistent with the target personality will be presented as valid alternatives to the original culprit.

2. Identification of culprits: if a word has a location in vector personality space that is near an extreme of a personality scale, it can be identified as a culprit. This leads to a greater number of words being identified than by sole use of the empirically derived lexicon.

The proposition that a personality score defined by a word's position in vector personality space provides a useful correspondence with the score defined by its position in personality space can be verified by testing scores of known words in the vector personality space.

Different distance metrics can be used within semantic space. Thus, a special distance metric can be created for establishing words' locations in vector personality space that creates the best match with the original, empirically defined scores. Such a metric can be constructed to ignore results that are outliers from normally accepted ranges.

FIGS. 1-4 illustrate an implementation of the system on a computer, where the personality style of text in a Microsoft Word® document is checked.

Firstly, a user can review and/or modify the configuration for the document, as illustrated in FIG. 1. Once the “configure PLC” icon 10 is selected, a dialogue box 12 is presented. The user can enter a location 14 for a personality data file to be located, and then can select personality options 16 to define a target personality. In this example, the personality parameters are psychoticism, extroversion, and neuroticism, and the user can select between projecting each of these characteristics negatively, positively, or neutrally. The user also has the option of setting the personality language checker to ignore any of these parameters.

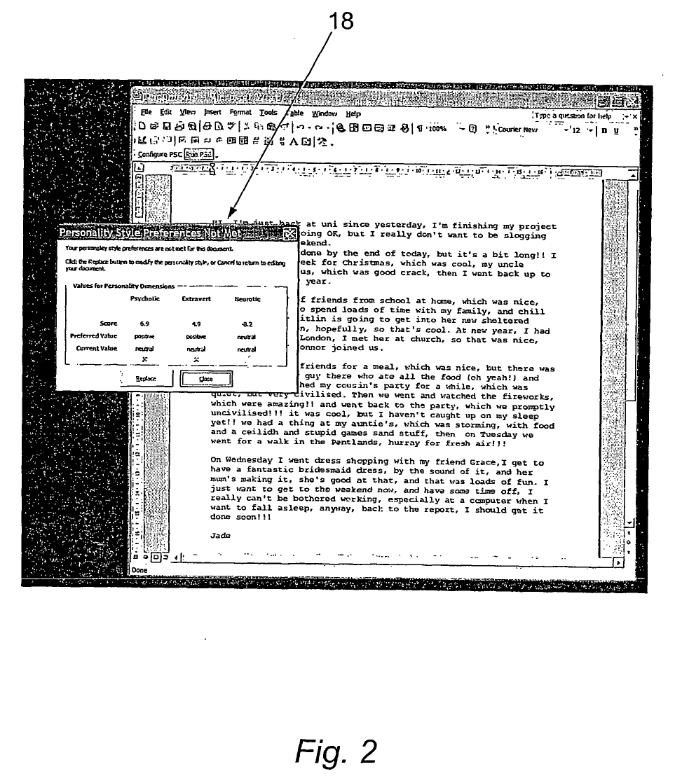

Once the configuration options are set, the user may then select the “run PSC” icon to calculate the personality score for the document. The scoring process is detailed below. As seen in FIG. 2, the score is displayed to the user in a score box 18. The box 18 shown gives a report showing that the text in the document does not match the set personality style preferences, and then gives the user the option either to proceed with the text replacement process or to cancel the operation. The text replacement process is detailed below.

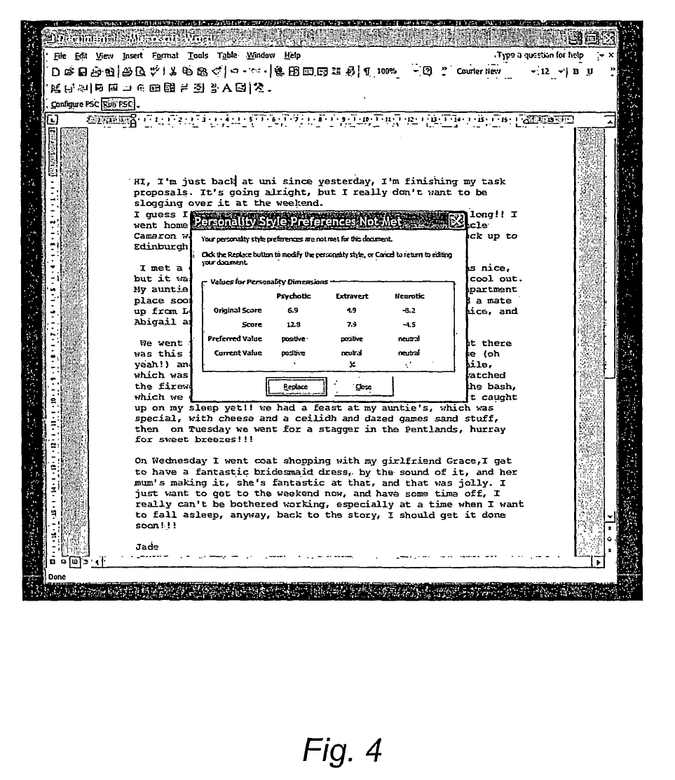

Following the replacement process, the personality score for the document is again calculated and displayed to the user. This may indicate that the text is now in line with the target personality, or it may indicate that there is still a mismatch, in which case the user may choose to repeat the replacement process. Such a case is illustrated in FIG. 4.

The scoring process will now be described in more detail.

Firstly, the accumulated score for each personality dimension and the count of words are both set to zero. Each word in the document text is then looked up in the personality word data file. If the word is present in the data, the count of words is incremented by 1 and for each personality dimension, the word's score on that dimension is added to the accumulated score on that dimension.

The final score for each dimension is then calculated by dividing the accumulated score by the count of words.

It will be appreciated that this scoring process is specific to this particular example.

The method of word replacement will now be described in more detail.

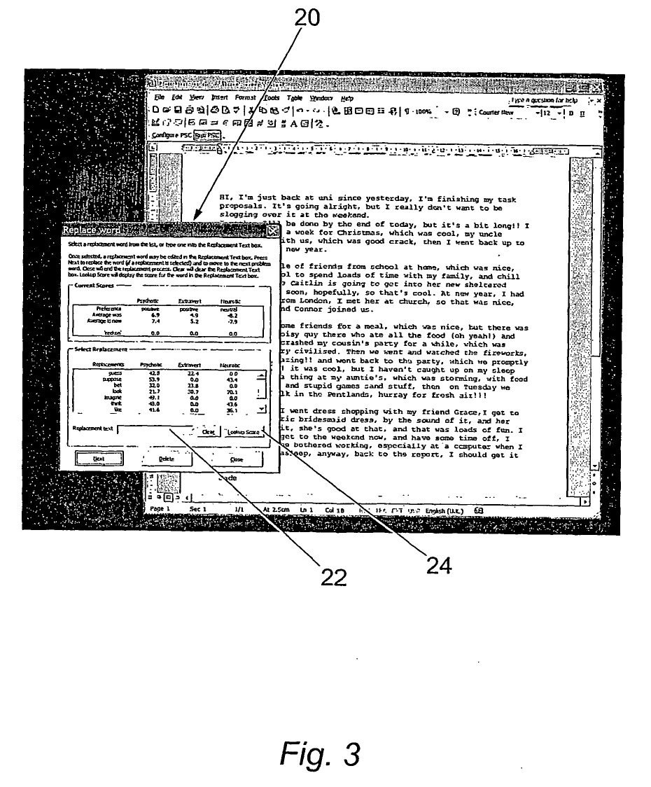

For each word that contributed to the document score, the entry in personality word data is found, and the list of alternative words is retrieved. Each alternative word is then looked up in the personality word data file, and it is determined whether substituting the alternative word for the selected word would move the document's score towards the preferred values (as set in the configuration). If so, the word is noted as a candidate for replacing the word. As seen in FIG. 3, the options are presented in a replacements dialogue box 20. In this case, the word “reckon” has been identified, and the user can choose from a list of candidate alternative words, including “guess”, “suppose”, “bet”, “look”, “imagine”, “think”, and “like”. The personality scores for each of these options is displayed. Alternatively, the user may delete the selected word, or may choose to substitute another word altogether. He can enter his own proposed word into the data field 22, and has the option of looking up that word's personality score via icon 24.

It will be apparent from the foregoing that the system can be implemented on standard computers by loading software which includes (1) the lexicon, (2) appropriate algorithms for analysing text passages and consulting the lexicon, and (3) an interface for cooperating with a given word processing package.

### REFERENCES

[1] Eysenck, H and Eysenck, S (1991) The Eysenck Personality Questionnaire—Revised, Hodder and Stoughton, Sevenoaks.
[2] Costa, P and McCrae, R R (1992) NEO PI-R Professional Manual, Psychological Assessment Resources, Odessa, Fla.
[3] Pennebaker, W and Francis, M (1999) Linguistic Enquiry and Word Count (LIWC), Lawrence Erlbaum Associates, Mahwah, N.J.
[4] Pennebaker, W and King, L (1999), Linguistic styles: Language use as an individual difference, Journal of Personality and Social Psychology, 77(6), 1296-1312.
[5] Coltheart, M (1981), the MRC Psycholinguistic Database, Quarterly journal of Experimental Psychology, 33.
[6] Ratnaparkhi, A (1996), A maximum entropy part-of-speech tagger, In Proc. Conference on Empirical Methods in Natural Language Processing, University of Pennsylvania.
[7] McDonald, S. (2000) Environmental determinants of lexical processing effort; PhD dissertation, University of Edinburgh

1. A method of processing text, comprising:
receiving a passage of text to be processed;
identifying words and/or sequences of words within the text passage;
checking each word or sequence of words against a lexicon of words and sequences of words each having associated therewith a score on at least one personality scale;
comparing said scores with a desired target personality on said personality scale; and
if the score has a predetermined degree of mismatch with the target personality, retrieving a word or sequence of words with a similar semantic content but a better matching score on the personality scale.

2. The method of claim 1, wherein the personality scale is a multi-parameter scale.

3. The method of claim 2, wherein the parameters comprise at least one of extraversion, neuroticism and psychoticism.

4. The method of claim 1, wherein the lexicon is derived from automated analysis of material from a statistical sample of subjects, the material including for each subject both personality test data and textual matter relating to one or more given topics.

5. The method of claim 1, wherein the lexicon is derived from a set corpus.

6. The method of claim 5, wherein the word in the set corpus are represented by vectors in a semantic space such that the vector distance between two words provides a measure of their difference in meaning, and the position of a target word on a personality scale in the semantic space is defined as its relative distance from two or more groups of words that are associated with the extrema of the personality scale.

7. The method of claim 1, wherein the lexicon is derived from a composite source comprising;
(a) words derived from automated analysis of material from a statistical sample of subjects, the material including for each subject both personality test data and textual matter relating to one or more given subjects; and
(b) a set corpus, in which the words may be represented by vectors in a semantic space such that the vector distance between two words provides a measure of their difference in meaning, and the position of a target word on a personality scale in the semantic space is defined as its relative distance from two or more groups of words that are associated with the extrema of the personality scale.

8. The method of claim 7, wherein each word or sequence of words is checked against source (a), which source is then used to initiate the step of retrieving a word or sequence of words with a similar semantic content but a better matching score on the personality scale, and, if no such word or sequence of words with a similar semantic content but a better matching score on the personality scale, and, if no such word or sequence of words is retrieved using source (a), a list of synonyms is collated using a thesaurus, which are checked against source (b) to carry out that step.

9. The method of claim 7, wherein each word or sequence of words is checked against source (b), which source is then used to initiate the step of retrieving a word or sequence of words with a similar semantic content but a better matching score on the personality scale.

10. A computer programmed to carry out the method as claimed in claim 1.

11. A data carrier carrying program data for effecting the method as claimed in claim 1.

12. A computer system containing data defining a lexicon, which lexicon comprises words and sequences of words each having associated therewith a score on one or more scales identifying the likelihood of the respective word or sequence of words being used by a person having a personality trait associated with that scale.

13. A data carrier carrying data defining a lexicon, which lexicon comprises words and sequences of words each having associated therewith a score on one or more scales identifying the likelihood of the respective word or sequence of words being used by a person having a personality trait associated with that scale.
